(19) United States
(12) Patent Application Publication
(10) Pub. No.: US 2007/0256067 A1
(43) Pub. Date: Nov. 1, 2007

(54) Method and system for upgrading a software image

(75) Inventors: Gurinderjit Chahal, Fremont, CA (US); Shashi Kumar, San Jose, CA (US)

Correspondence Address: LAW OFFICE OF CHARLES E. KRUEGER, P.O. BOX 5607, WALNUT CREEK, CA, 94596-1607, US

(73) Assignee: CISCO TECHNOLOGY, INC. (A California Corporation)

(21) Appl. No.: 11/411,610

(22) Filed: Apr. 26, 2006

(51) Int. Cl. G06F 9/44

(52) U.S. Cl. 717/168

(57) ABSTRACT

A system and method of upgrading a software image on a device that automatically saves information regarding important settings on the device prior to the upgrade. The same set of information is obtained after the upgrade and compared with stored information to determine whether any changes have occurred due to activating the upgrade. The results of the comparison are reported to a user.

### BACKGROUND OF THE INVENTION

Manufacturers and distributors of software periodically provide software upgrades for a number of reasons. The need for upgrades has been especially acute because of hacker attacks on software with security flaws. Many manufacturers are constantly upgrading existing versions of their software to patch security flaws. Another reason to upgrade is to include new features in the software to maintain a competitive edge or to respond to customer requests for new or improved features.

However, customers are wary of upgrades for a number of reasons. Many small businesses rely on current versions of software that are crucial to servicing customers and running the business. Thus, even if the new features offered in an upgrade would be useful to the business, there is a reluctance to install an upgrade because of potential problems that can be caused by the upgrade. This reluctance is partially due to the lack of resources in the small business to identify and fix problems caused by the installation of a software upgrade.

Large businesses have labs that resemble the production environment and have computer professionals who can test a new software image, resulting from an upgrade, in the lab environment before rolling out the new image into the production environment. However, as described above, in small to medium businesses there is often no computer professional on site and the existence of a lab is very rare.

Accordingly, in order to decrease customer reluctance to install software upgrades, techniques are needed by software manufacturers and distributors to facilitate the upgrading of installed software.

### BRIEF DESCRIPTION OF THE DRAWINGS

FIG. 1 is a block diagram of an embodiment of the invention;

FIG. 2 is a flow chart depicting the actions performed at device initialization;

FIG. 3 is a flow chart depicting the actions performed when a current image is verified; and

FIG. 4 is a flow chart depicting the actions performed when an image is upgraded.

### DETAILED DESCRIPTION OF THE INVENTION

Reference will now be made in detail to various embodiments of the invention. Examples of these embodiments are illustrated in the accompanying drawings.

While the invention will be described in conjunction with these embodiments, it will be understood that it is not intended to limit the invention to any embodiment. On the contrary, it is intended to cover alternatives, modifications, and equivalents as may be included within the spirit and scope of the invention as defined by the appended claims. In the following description, numerous specific details are set forth in order to provide a thorough understanding of the various embodiments. However, the present invention may be practiced without some or all of these specific details. In other instances, well known process operations have not been described in detail in order not to unnecessarily obscure the present invention.

An embodiment of the invention will now be described by way of example, not limitation, that is implemented on a network device such as a switch or router. In this embodiment a set of tests are identified that need to be run on a network device and these tests are run automatically by the software running on the network device. The results of the tests are saved in non-volatile storage on the device. The software image on the network device is then upgraded to form a new software image and the new software image is activated. The new software image then performs the same set of tests and compares the results obtained with the saved results to determine if system performance has changed as a result of the upgrade.

Any changes are reported so that the user is aware of the changes that have occurred and can take appropriate action. For example, if the changes reported degrade the performance of the device then the new image can be uninstalled. Alternatively, the new image can be reconfigured to undo undesired changes.

In this embodiment, each feature of the software image has an associated set of tests. A feature can be enabled so that the tests associated with the feature are run before and after an upgrade of the software image.

The following are some examples of features and associated tests:
1. The Link Detection feature can record the state of each port including final duplex and speed settings after auto-negotiation
2. Features such as Cisco Discovery Protocol can record the neighbor discovered on each port.
3. The IP Protocol Stack can check the connectivity to the default gateway, DNS servers, etc.
4. The Spanning Tree Protocol (STP) can save information about the state of each port for each STP instance, as well as the root bridge for the instance.

Other features have similar associated tests specific to the feature. In this embodiment, the user registers features which are to be verified after a software upgrade. A standard set of features may be automatically registered by default.

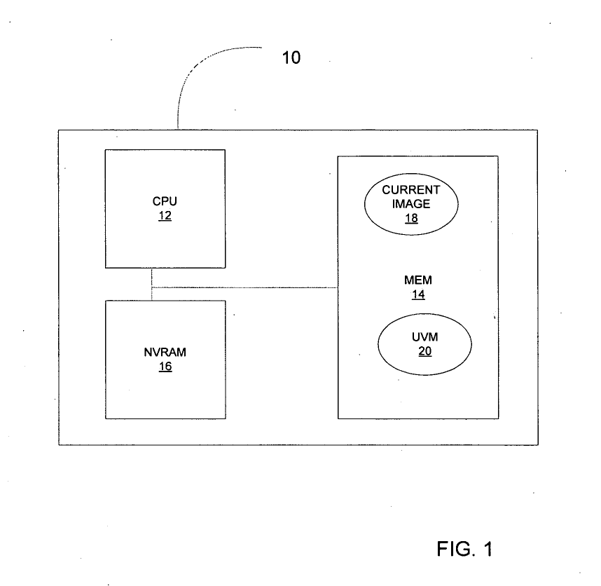

The operation of this embodiment will now be described in greater detail. FIG. 1 depicts a network device 10 that includes a CPU 12, memory 14, and non-volatile storage 16. The memory 14 holds a current image 18 and an Upgrade Verification Module 20 that is executed by the CPU 12 to perform functions described below.

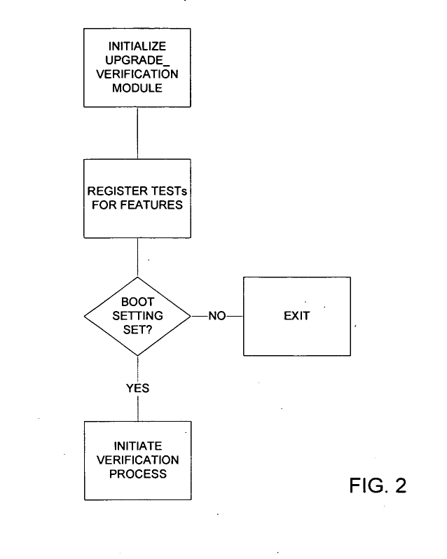

As depicted in the flowchart of FIG. 2, the following steps are performed at device initialization each time the switch software image boots up:
1. The Upgrade Verification module is initialized.
2. Each feature registers a set of tests and functions that can be called to execute the tests.
3. After configuration is complete, the Upgrade Verification module checks the boot setting (that indicates whether the image must be verified), and if set initiates the verification process.

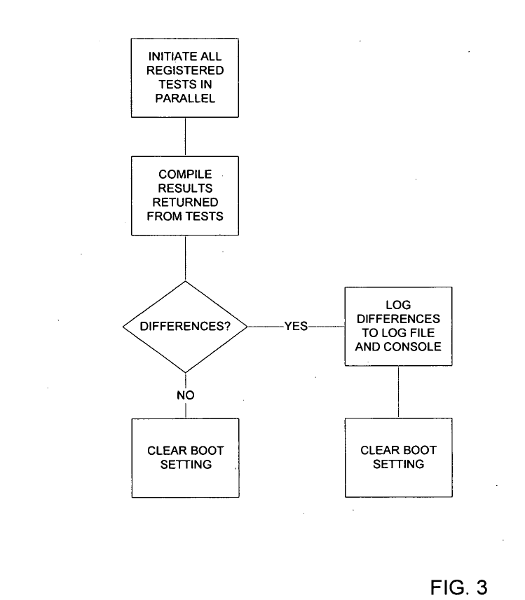

If the current image is running for the first time then the boot setting indicates that the image should be verified. As depicted in the flow chart of FIG. 3, the following steps are performed when the current image is verified:
1. All of the tests registered at the time of initialization are started in parallel.
2. Each test upon completion returns the results of the test.
3. The results of all the tests are compiled, and compared against any previously saved results.
4. The differences in the results, if any, are logged to a file, and a message is logged to the system log and console summarizing the verification results.
5. The boot setting is cleared. The user may set the boot setting again so that the tests are performed again when the device restarts.

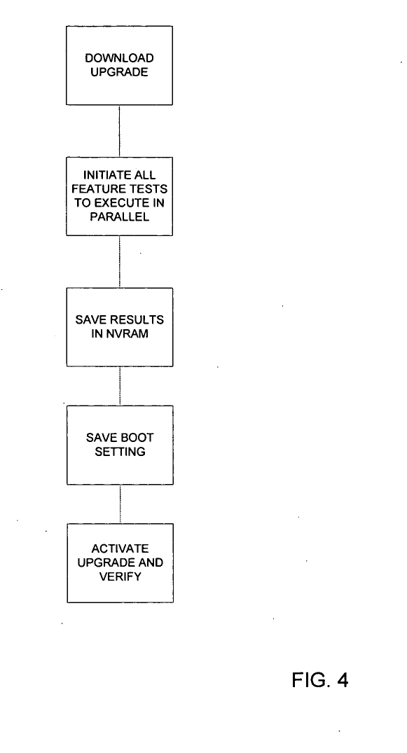

The results of the tests are stored in memory so that they serve as a reference for subsequent testing when the current image is upgraded. When the customer wishes to upgrade the current image the steps depicted in FIG. 4 are performed:
1. When user requests upgrading of the image, the new software image is downloaded.
2. Before resetting the device to activate the new image, each of the feature tests that has been registered is initiated.
3. The tests execute in parallel, and the results of the tests are saved in a file on the non-volatile storage upon the completion of the tests.
4. The boot setting is saved to indicate that the new image must perform the verification of the functionality when activated.

These steps save the test results for the current image before the upgraded image is activated. The new image is now the current image and when it is activated the steps described above with reference to FIG. 2 are performed when the device is initialized with the new current image. As described above, the test results of the previous current image, now the “old” image were stored. So the differences logged to the system log and console indicate any changes resulting from the installation of the upgrade. In this embodiment verification happens when a software upgrade has been initiated (item 2 above) and when in image is booting up if the boot setting indicates that verification should be performed (item 4 above).

The invention may be implemented as program code, stored on a computer readable medium, that is executed by a digital computer. The computer readable medium may include, among other things, magnetic media, optical media, electromagnetic fields encoding digital information, and so on.

The invention has now been described with reference to the preferred embodiments. Alternatives and substitutions will now be apparent to persons of skill in the art. For example, in the above description the tests are run in parallel however some tests could be run separately. Different techniques for reporting or acting on differences detected during verification can be implemented as understood by persons of ordinary skill in the art. Additionally, the invention is not limited to network devices but can be implemented on any computing system when software is to be upgraded. Accordingly, it is not intended to limit the invention except as provided by the appended claims.

What is claimed is:

1. A method for updating software on a device comprising:
running a set of tests to determine a first set of test results indicating conditions on the device prior to upgrading the software;
saving the first set of test results;
upgrading the software;
activating upgraded software;
running the set of tests again after the upgraded software is activated to determine a second set of test results;
comparing the first and second sets of test results; and
reporting any changes between the first and second sets of test results.

2. The method of claim 1 where said step of saving further comprises:
saving the results as a log file in non-volatile memory.

3. The method of claim 1 where the tests are run in parallel.

4. The method of claim 1 further comprising:
checking a boot setting to determine whether to run the tests.

5. A system for updating software on a device comprising:
means for running a set of tests to determine a first set of test results indicating conditions on the device prior to upgrading the software;
means for saving the first set of test results;
means for upgrading the software;
means for activating upgraded software;
means for running the set of tests again after the upgraded software is activated to determine a second set of test results;
means for comparing the first and second sets of test results; and
means for reporting any changes between the first and second sets of test results.

6. The system of claim 5 where said means for saving further comprises:
means for saving the results as a log file in non-volatile memory.

7. The system of claim 5 where the tests are run in parallel.

8. The system of claim 5 further comprising:
means for checking a boot setting to determine whether to run the tests.

9. A computer program product executed by a processor for updating software on a device comprising:
a computer usable medium having computer readable program code physically embodied therein, said computer program product further comprising:
computer readable program code executed by the processor for running a set of tests to determine a first set of test results indicating conditions on the device prior to upgrading the software;
computer readable program code executed by the processor for saving the first set of test results;
computer readable program code executed by the processor for upgrading the software;
computer readable program code executed by the processor for activating upgraded software;
computer readable program code executed by the processor for running the set of tests again after the upgraded software is activated to determine a second set of test results;
computer readable program code executed by the processor for comparing the first and second sets of test results; and
computer readable program code executed by the processor for reporting any changes between the first and second sets of test results.

10. The computer program product of claim 9 where said computer readable program code executed by the processor for saving further comprises:
computer readable program code executed by the processor for saving the results as a log file in non-volatile memory.

11. The computer program product of claim 9 where the tests are run in parallel.

12. The computer program product of claim 9 further comprising:
computer readable program code executed by the processor for checking a boot setting to determine whether to run the tests.

13. A system for updating software on a device comprising:
a memory holding current image and upgrade verification program code and holding data;
a processor, coupled to the memory, with the processor configured to execute the program code to run a set of tests to determine a first set of test results indicating conditions on the device prior to upgrading the current image, save the first set of test results, upgrade the current image to form an upgraded image, activate the upgraded image, run the set of tests again after the upgraded image is activated to determine a second set of test results, compare the first and second sets of test results, and report any changes between the first and second sets of test results.

14. The system of claim 13 where said processor is further configured to:
save the results as a log file in non-volatile memory.

15. The system of claim 13 where the processor is configured to run the tests in parallel.

16. The system of claim 13 where the processor is configured check a boot setting to determine whether to run the tests.
